(19) United States
(12) Patent Application Publication
(10) Pub. No.: US 2001/0054156 A1
(43) Pub. Date: Dec. 20, 2001

(54) Image processing method and apparatus and image processing system

(76) Inventor: Minoru Teshigawara, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/879,994

(22) Filed: Jun. 14, 2001

(30) Foreign Application Priority Data
Jun. 19, 2000 (JP) 2000-182902
Jun. 4, 2001 (JP) 2001-168369

(51) Int. Cl. H04L 9/32

(52) U.S. Cl. 713/194; 380/54

(57) ABSTRACT

If a tracking pattern superimposed on print data is discriminated, a malicious user may tamper the pattern, resulting in a deterioration in the reliability of the tracking pattern itself. According to this invention, therefore, a tracking pattern generating unit generates a tracking pattern, and a data addition processing unit adds the tracking pattern to image data. An encryption processing unit encrypts the image data to which the tracking pattern is added to make it difficult to detect that the tracking pattern is added, and transmits the resultant data to a printing apparatus. This makes it difficult to discriminate the tracking pattern from the image data, thus providing the highly reliable tracking pattern.

### FIELD OF THE INVENTION

The present invention relates to an image processing method and apparatus for forming an image to which a tracking pattern is added, and an image processing system.

### BACKGROUND OF THE INVENTION

Recently, for color image forming apparatuses such as color printers and copying machines, various image forming schemes, e.g., silver halide printing, thermal printing, electrophotographic printing, electrostatic printing, and ink-jet printing schemes, have been developed. These apparatuses have greatly improved in performance and have widely been used. Therefore, high-quality color images can be easily obtained by using color image forming apparatuses.

To easily obtain high-quality color images is to easily counterfeit bills and securities by using full-color image forming apparatuses. This poses a criminal problem. To prevent such a problem, recent full-color image forming apparatus need to have various counterfeit prevention functions.

As a conventional method of realizing such a counterfeit prevention function, a method of superimposing some information on an image to be formed has been known. This information is, for example, a tracking pattern which is a regular dot pattern or the like which represents the information (machine type number or machine number) of an image forming apparatus or personal information (e.g., a user, time, or place). When an image whose formation is prohibited is found, the above information is detected from the dot pattern superimposed on the image, thereby specifying the apparatus that has formed the image. This information is acquired in the process of forming print data, and is added to image data processed by a printer driver (a program for controlling printing processing). The resultant data is then output.

A dot pattern used in this scheme is superimposed on all images output from the image forming apparatus, and hence is preferably superimposed by using a yellow or transparent printing agent (toner, ink, or the like) that is not easily identified by the human eye. The density of this pattern is preferably low because it becomes less noticeable. To allow a pattern to be deciphered even from an image with a relatively small size, such as a postage stamp, and improve the reliability in deciphering the pattern, the intervals between the elements of the pattern to be superimposed are required to be minimized.

In the above prior art, however, if a malicious user superimposes a tracking pattern on the above print data and the position of the tracking pattern is discriminated, the tracking pattern may be tampered. This leads to a deterioration in the reliability of the tracking pattern itself.

### SUMMARY OF THE INVENTION

The present invention has been proposed to solve the conventional problems, and has as its object to provide an image processing method and apparatus which improve the reliability of an image to which a tracking pattern is added.

According to the present invention, the foregoing object is attained by providing an image processing apparatus comprising: additional information generating means for generating additional information; adding means for adding the additional information to image data to generate information-added data; and encrypting means for encrypting the information-added data to make it difficult to detect that the additional information is added.

In accordance with the present invention as described above, an image to which a tracking pattern can be encrypted.

In addition, the present invention is characterized by further including transmitting means for transmitting the image data encrypted by the encrypting means to a connected image forming apparatus.

With this arrangement, the image forming apparatus can form an image to which a proper tracking pattern is added.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the schematic arrangement of a system according to an embodiment of the present invention;

FIG. 2 is a block diagram showing an arrangement for implementing PC development processing;

FIG. 3 is a schematic view showing the flow of print data from a PC into a printer;

FIG. 4 is a perspective view schematically showing a printer mechanism;

FIG. 5 is a block diagram showing an example of the arrangement of the control system of the printer;

FIGS. 6A to 6C are views showing tracking pattern samples;

FIG. 7 is a flow chart showing tracking pattern forming processing;

FIG. 8 is a flow chart showing network ID acquisition processing;

FIG. 9 is a flow chart showing encryption processing; and

FIG. 10 is a view showing an example of encryption.

### DETAILED DESCRIPTION OF THE PREFERRED EMBODIMENTS

Preferred embodiments of the present invention will now be described in detail in accordance with the accompanying drawings.

### Arrangement of System

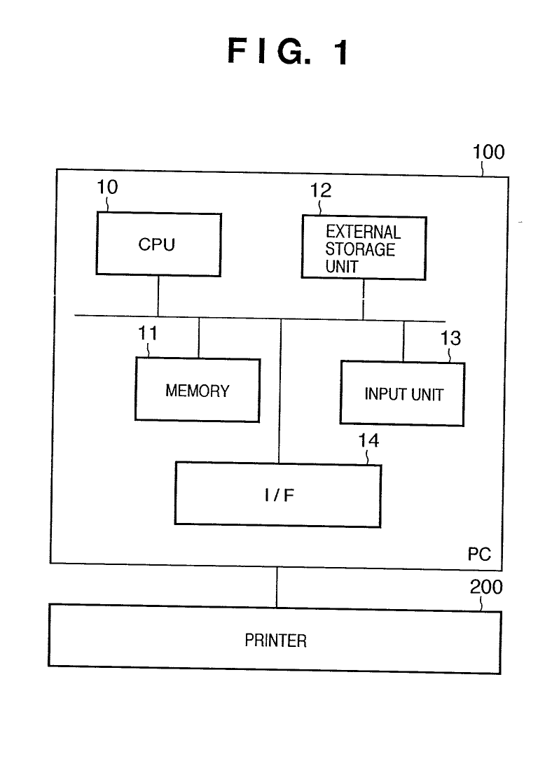

FIG. 1 is a view showing the schematic arrangement of an overall system according to an embodiment of the present invention.

This system is comprised of a host computer (to be referred to as a PC hereinafter) 100 serving as an information processing apparatus and an ink-jet printer (to be referred to as a printer hereinafter) 200 serving as a printing apparatus.

Referring to FIG. 1, the PC 100 includes a CPU 10, a memory 11, an external storage unit 12 such as a hard disk, an input unit 13 such as a keyboard or mouse, an interface 14 for the printer 200, and the like.

The CPU 10 reads out a printing program stored as a program, a part of a so-called printer driver, from the external storage unit 12 or an external apparatus, and stores it in the memory 11. The CPU 10 performs image processing such as color processing, density correction processing, and quantization processing for original image data in accordance with the printing program stored in the memory 11. The PC 100 is connected to the printer 200 through the interface 14, transmits image data having undergone the above processing in accordance with the printing program to the printer 200, and causes the printer 200 to print it.

The above printing processing is substantially equivalent to setting a printer driver for the printer 200 on the PC 100 side. The PC 100 executes various types of image processing, e.g., rasterizing processing, color conversion processing, output γ processing, and quantization processing in accordance with the printing program. The PC 100 converts the original image data to be printed into binary bit image data that can be directly expressed by the printhead of the printing apparatus, and outputs the data obtained by this conversion to the printer 200. Various types of image processing performed on the PC 100 side will be referred to as PC development processing hereinafter.

The main part of the present invention in PC development processing performed by the printer driver on the PC 100 side will be described next.

### PC Development Processing

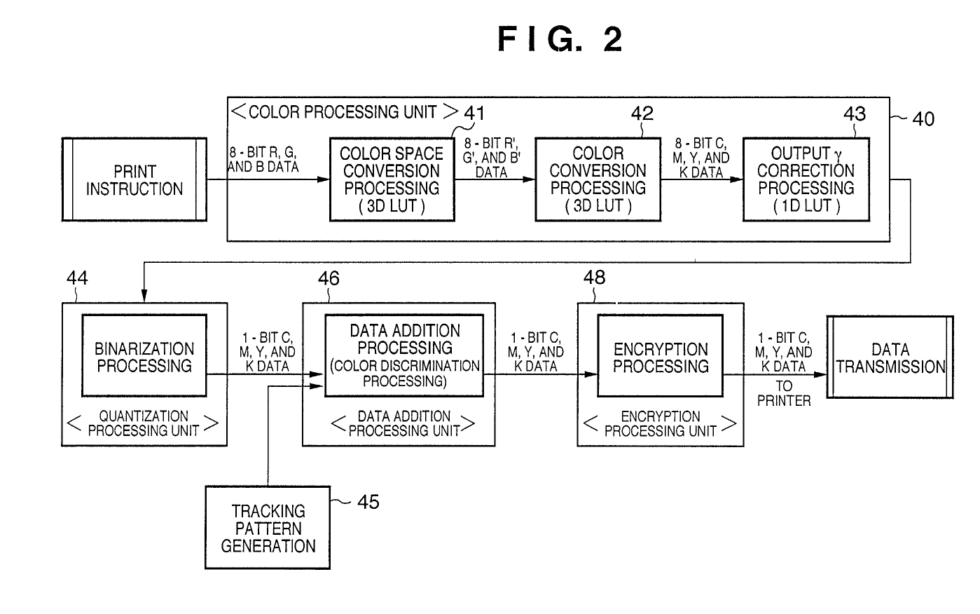

FIG. 2 is a block diagram showing the functional arrangement of the above PC development processing in the PC 100.

The PC development processing according to this embodiment includes color processing performed by a color processing unit 40, binarization processing performed by a quantization processing unit 44, data addition processing performed by a data addition processing unit 46, and encryption processing performed by an encryption processing unit 48. By this PC development processing, original image data constituted by 8-bit R, G, and B data (256 grayscale levels) provided by an application program or the like is converted into binary data constituted by 1-bit C, M, Y, and K data, data representing a tracking pattern is added to the binary data, the data is encrypted, and the resultant data is output.

First of all, the color processing unit 40 receives the rasterized original image data constituted by 8-bit R, G, and B data. The original image data is converted into 8-bit R′, G′, and B′ data by color space conversion processing (first color processing) by using a 3D lookup table (LUT) 41 in order to correct the difference between the color space of the input image and the reproduction color space of the output device.

The 8-bit R′, G′, and B′ data after the color space conversion processing are converted into 8-bit, C, M, Y, and K data by using a next 3D LUT 42. This processing is called color conversion processing (second color processing), which is performed to convert RGB-based color image data in the input system into CMYK-based color image data in the output system. Input data are often image data about the three primary colors (R, G, and B) based on an additive process so that they can be displayed on a light-emitting device such as a display. In contrast to this, when data is to be output by a printer or the like, the image to be reproduced is formed by using the reflection of light. In this case, coloring materials of the three primary colors (C, M, and Y) based on a subtractive process are used. For this reason, this color conversion processing is performed.

Each of 3D LUTs 41 and 42 used for first color processing and second color processing holds discrete data, and the values between the data are calculated by interpolation.

Output γ correction processing (density correction processing) is performed for the 8-bit C, M, Y, and K data, which have undergone second color processing, by using a 1D LUT 43. This correction processing is performed because the relationship between the number of printed dots per unit area and output characteristics (e.g., reflection density) is not linear in many cases. That is, this processing is performed to guarantee the linear relationship between the input level of 8-bit C, M, Y, and K data and output characteristics.

The 8-bit C, M, Y, and K multilevel data output from the color processing unit 40 are input to the quantization processing unit 44 to be subjected to binarization processing. This binarization processing is performed by using a known error diffusion method to quantize the input 8-bit C, M, Y, and K multilevel data into 1-bit C, M, Y, and K data.

After this quantization processing, the 1-bit C, M, Y. and K binary data are input to the data addition processing unit 46, together with the tracking pattern data generated by a tracking pattern generating unit 45 upon reception of a print instruction. The data addition processing unit 46 adds this tracking pattern data to the 1-bit C, M, Y, and K binary data and inputs the resultant data to the encryption processing unit 48.

The encryption processing unit 48 performs encryption processing (to be described later) for the data obtained by the addition processing, and outputs the resultant data as print data to the printer 200. With this operation, the PC development processing is completed.

In this manner, the PC 100 encrypts the image data to which the tracking pattern is added, and transmits the resultant data to the printer 200. Since this makes it difficult to detect that the tracking pattern is added in the transmitted image data and the position where the pattern is added, the reliability of the tracking pattern improves.

If it is necessary to store image data, to which a tracking pattern is added, in the memory 11, external storage unit 12, or the like before it is transmitted to the printer 200, it is preferable to store the image data after encryption.

### Printing Processing

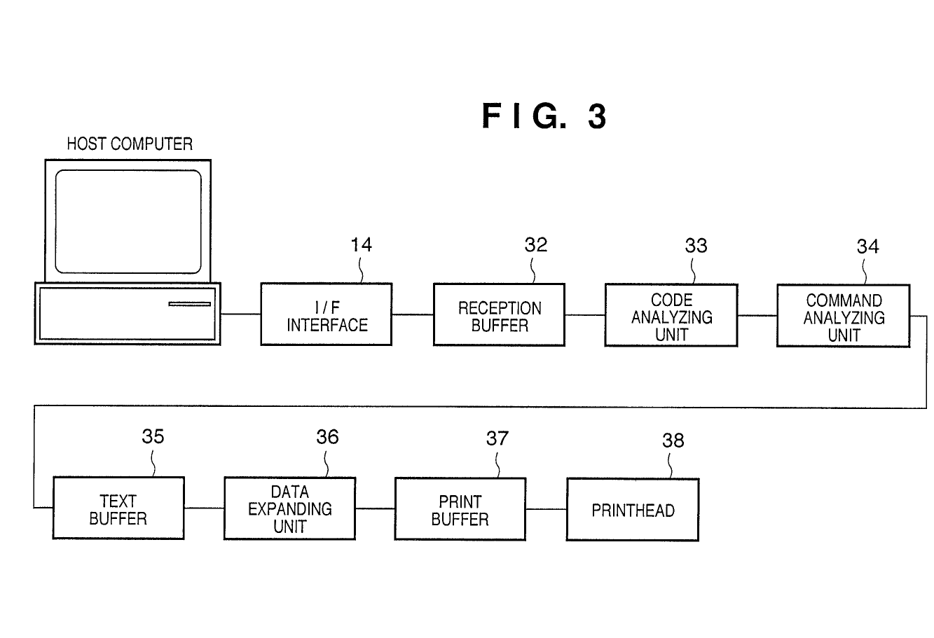

The flow of processing up to the time when the print data transmitted from the PC 100 side is printed in the printer 200 will be described next with reference to FIG. 3.

The encrypted print data transmitted from the PC 100 is stored in a reception buffer 32 in the printer 200 through the interface 14.

In the printer 200, a code analyzing unit 33 decrypts the print data stored in the reception buffer 32, i.e., the encrypted data, into the original signal by using predetermined information for decrypting the encrypted data. The predetermined information for decryption is called “key information”, which is held in a memory (not shown) or the like in the printer 200.

The decrypted print data is sent to a command analyzing unit 34 to analyze a command contained in the decrypted print data. After the command analysis, the data is sent to a text buffer 35.

In the text buffer 35, the print data is held in an intermediate form, to which the print positions and sizes of the respective characters and the like, characters (codes), font address, and the like are added.

A data expanding unit 36 expands the print data stored in the text buffer 35 and stores the data in a binarized state in a print buffer 37. After the expansion, the print data is sent as print data to a printhead 38 to perform printing.

Note that some printer 200 is designed to simultaneously perform command analysis and data expansion for the print data stored in the reception buffer 32 without using the text buffer 35 and write the resultant data in the print buffer 37.

The printer 200 of this embodiment will be described in detail next.

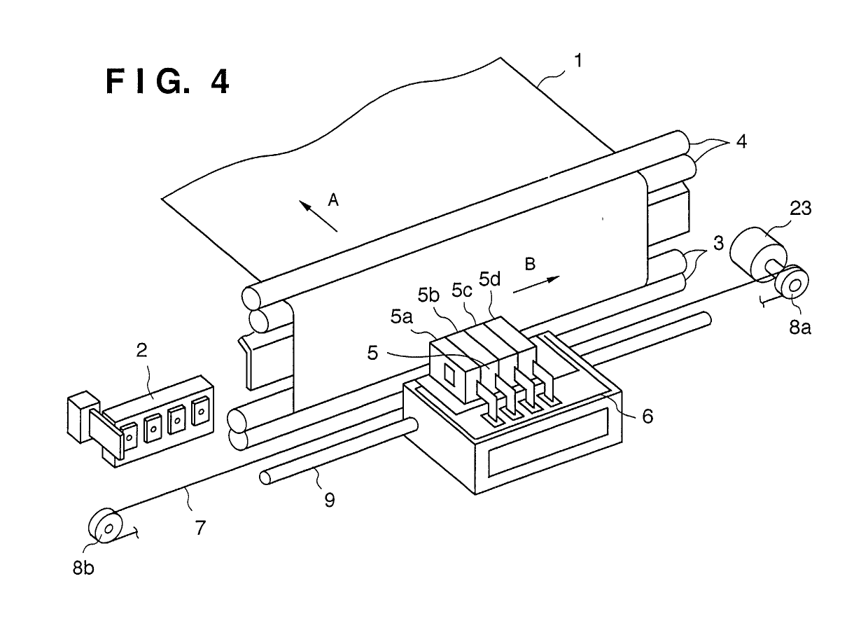

FIG. 4 is a perspective view showing the printer 200 based on the ink-jet printing scheme according to this embodiment. The overall arrangement of the printer 200 will be described first. Referring to FIG. 4, reference numeral 1 denotes a printing medium formed by paper or a plastic sheet. A plurality of sheets 1 stacked on a cassette or the like are fed one by one by a feed roller (not shown) and conveyed in the direction indicated by an arrow A by first and second convey roller pairs 3 and 4 which are placed at a predetermined distance from each other and respectively driven by stepping motors (not shown).

Reference numeral 5 denotes an ink-jet printhead for printing images on the printing sheet 1. The printhead 5 is made up of heads 5a, 5b, 5c, and 5d for discharging Y (yellow) ink, M (magenta) ink, C (cyan) ink, and Bk (black) ink, respectively. Ink is fed from an ink cartridge (not shown) and discharged from nozzles of each head-in accordance with an image signal. This printhead 5 and ink cartridge are mounted in a carriage 6. A carriage motor 23 is coupled to the carriage 6 via a belt 7 and pulleys 8a and 8b. That is, the carriage 6 is reciprocally scanned along a guide shaft 9 by the carriage motor 23.

With the above arrangement, the printhead 5 discharges ink onto the printing sheet 1 while moving in the direction indicated by an arrow B in accordance with an image signal, thereby printing an ink image. The printhead 5 then returns to the home position as needed, and an ink restoring device 2 eliminates nozzle clogging. In addition, the convey roller pairs 3 and 4 are driven to convey the printing sheet 1 by one line in the direction indicated by the arrow A. The above operation is repeated to perform a predetermined printing operation on the printing sheet 1.

A control system for driving each member of the printing apparatus will be described next.

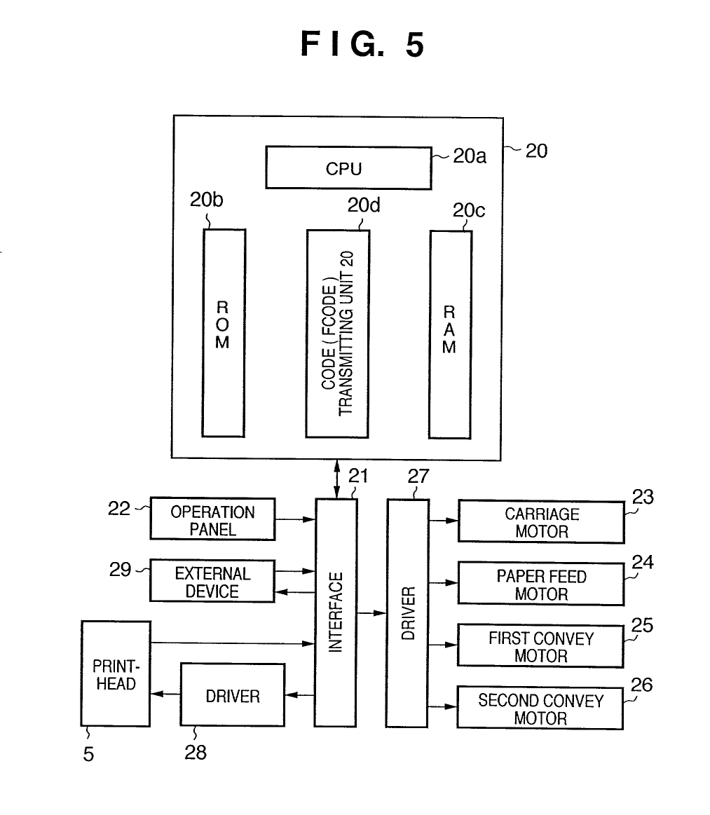

As shown in FIG. 5, the control system in the printer 200 of this embodiment is comprised of a control unit 20 including a CPU 20a such as a microprocessor, a ROM 20b storing control programs for the CPU 20a and various data, a RAM 20c which is used as a work area for the CPU 20a and temporarily stores various data, and a code transmitting unit 20d for transmitting FCODE to the PC 100, which will be described in detail later, an interface 21, an operation panel 22, a driver 27 for driving motors (carriage driving motor 23, paper feed motor driving motor 24, first convey roller pair driving motor 25, and second convey roller pair driving motor 26), and a driver 28 for driving the printhead 5.

In the above arrangement, the control unit 20 receives various kinds of information (e.g., a character pitch, character type, and the like) from the operation panel 22 through the interface 21 and also receives an image signal from an external device 29 (the PC 100 in this embodiment). In addition, the control unit 20 outputs ON and OFF signals for driving the motors 23 to 26 and image signals through the interface 21, and drives the respective members by using the image signals.

### Addition of Tracking Pattern

Addition of a tracking pattern which is executed in the above PC development processing will be described in detail below.

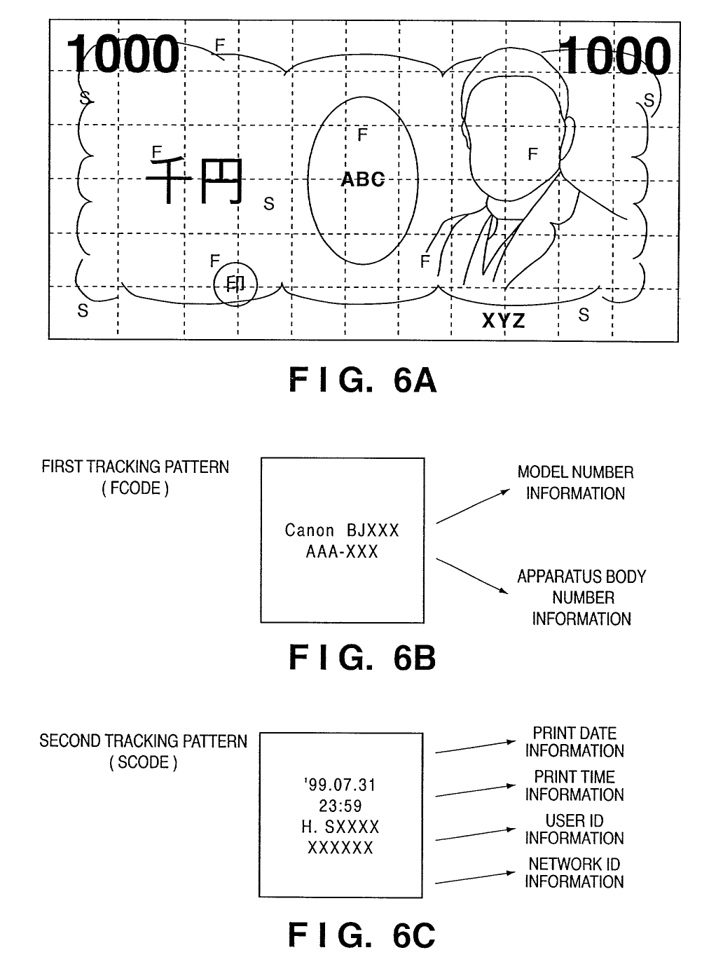

FIGS. 6A to 6C are views showing tracking pattern samples in this embodiment. FIGS. 6B and 6C respectively show a first pattern (FCODE) and second pattern (SCODE) as tracking pattern samples in this embodiment, and FIG. 6A shows a printed sample having these tracking patterns added on an image.

Referring to FIGS. 6B and 6C, each area enclosed with a frame indicates a tracking pattern unit. In this case, the first pattern indicates apparatus body information such as model number information and apparatus body number information, and the second pattern indicates environmental information such as print date information, print time information, user ID information, and network ID information.

The letters “F” and “S” in FIG. 6A indicate that the first and second patterns are added at the corresponding positions, respectively. These patterns are repeatedly added on the image on the printing sheet vertically and horizontally to be spaced apart from each other.

Dots in each area are preferably superimposed on the image by using a printing agent that is low in visibility, e.g., a yellow or transparent printing agent that is difficult to identify by the human eye. Some pattern is formed by minute yellow dots with hollow dots adjacent to each yellow dot so as to decrease the density of dots and make the pattern less noticeable. In this embodiment, such patterns are added to image data by PC development processing.

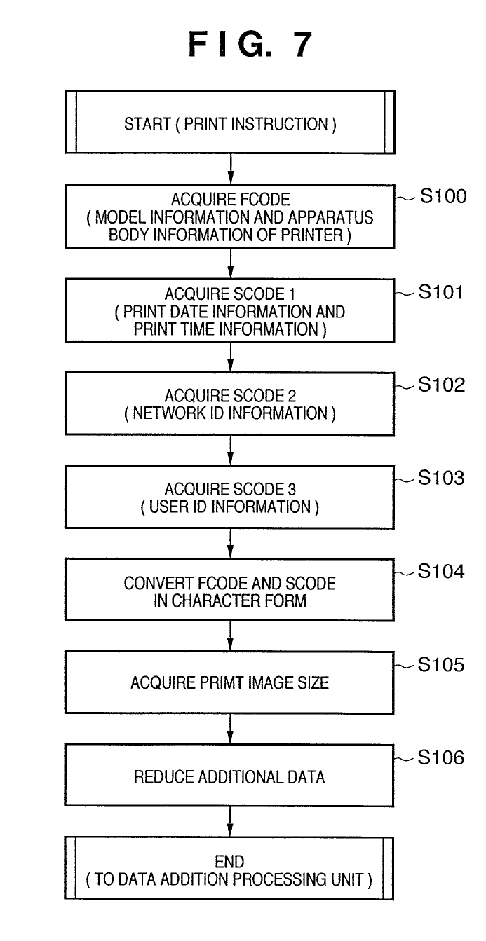

FIG. 7 is a flow chart showing tracking pattern generation processing in the tracking pattern generating unit 45 in the PC 100.

When the PC 100 executes printing operation through an application, the model number and apparatus body number of the printing apparatus, stored in the ROM 20b in the printer 200, are transmitted as code data (FCODE) representing the first pattern to the PC 100 through the interface 14 in step S100.

In step S101, the PC 100 acquires a print date and current time (CLK) indicating time information as code data 1 (SCODE1) representing the second pattern from its own CPU 10.

In step S102, the PC 100 acquires its own network ID (NID) as code data 2 (SCODE2) representing the second pattern. In step S103, the PC 100 acquires a user ID (UID) as code data 3 (SCODE3).

If any one of SCODE1 to SCODE3 representing the second pattern cannot be acquired, the PC 100 skips the step of acquiring them.

The acquired information of SCODE1 to SCODE3 is stored in the memory 11 in the PC 100 or a memory (not shown) in the tracking pattern generating unit 45.

In step S104, these code data (FCODE and SCODE1 to SCODE3) are converted into data in a character form in the tracking pattern generating unit 45, and the size of original image data to be printed is discriminated in step S105. In step S106, the code data in the character form is reduced on the basis of a predetermined reduction ratio corresponding to the discriminated image size.

The code data generated in the above manner is output to the data addition processing unit 46 to be binarized. This binarized data is then synthesized with the binary original image data. In this synthesis processing, the color designation commands of the original image data are discriminated, and each code data is added to image data having a color component (e.g., yellow component) to which the code data should be added. To alternately arrange these code data in the column and raster directions, the code data are repeatedly added to the original image data. The addition cycle may be fixed or random.

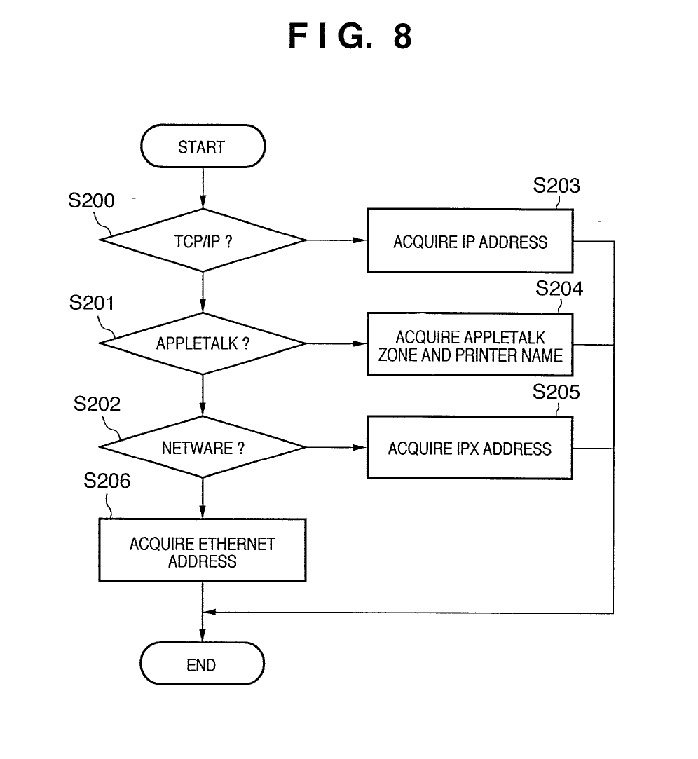

FIG. 8 is a flow chart showing acquisition processing for a network ID (NID) as code data 2 (SCODE2) in step S102.

Assume that in the following description, the PC 100 supports Ethernet, Netware (trade name), Appletalk (trade name), or TCP/IP as its network form.

In step S200, the PC 100 checks whether the connected network is a TCP/IP network. If the connected network is a TCP/IP network, the flow advances to step S203 to acquire an IP address as an NID.

If it is determined in step S200 that the connected network is not a TCP/IP network, the flow advances to step S201 to check whether the connected network is an Appletalk network. If it is determined that the connected network is an Appletalk network, the flow advances to step S204 to acquire Appletalk Zone and a printer name as an NID.

If it is determined in step S201 that the connected network is not an Appletalk network, the flow advances to step S202 to check whether the connected network is a Netware network. If it is determined that the connected network is a Netware network, the flow advances to step S205 to acquire an IPX address as an NID.

If it is determined in step S202 that the connected network is not a Netware network, it is determined that the connected network is an Ethernet network. In step S206, an Ethernet address is acquired as an NID.

In this manner, in this embodiment, a proper NID can be acquired in accordance with the type of network connected.

### Encryption Processing

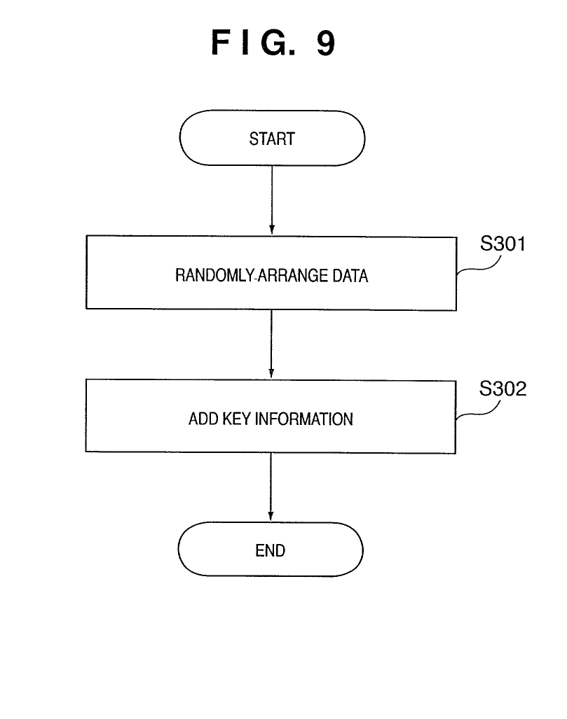

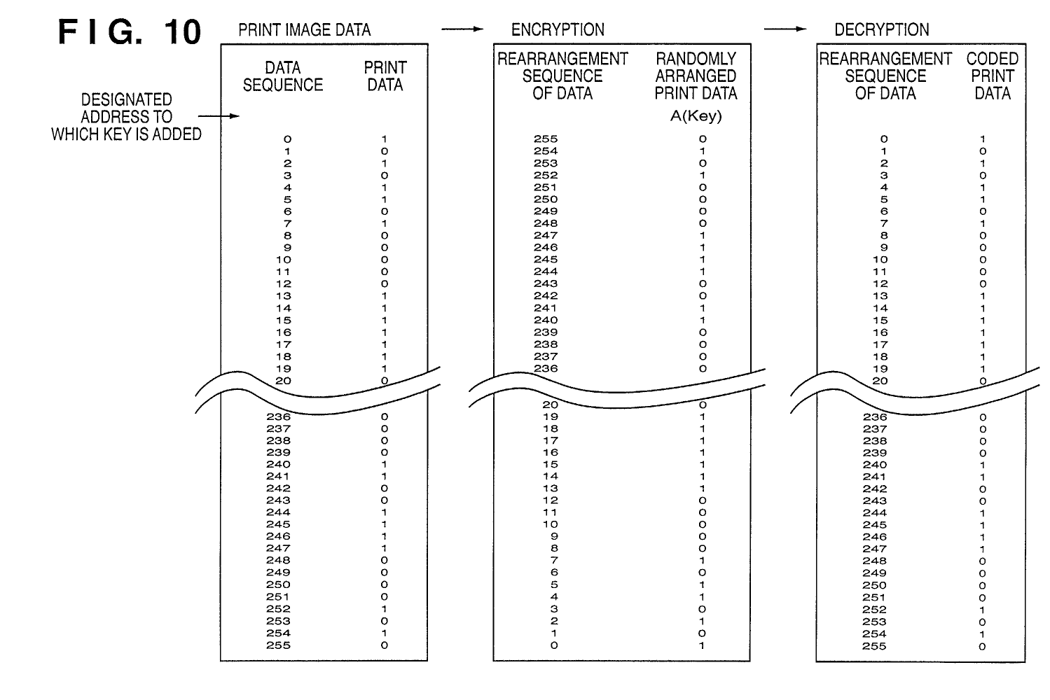

Encryption processing in this embodiment will be described in detail below with reference to FIGS. 9 and 10.

In this embodiment, in the encryption processing unit 48 shown in FIG. 2, image data to which a tracking pattern is added is encrypted to make it difficult to detect that the pattern is added and/or the position where the pattern is added.

FIG. 9 is a flow chart showing encryption processing in the encryption processing unit 48. FIG. 10 is a view showing an example of encrypted data.

In step S301, the CMYK data (to be referred to as print data hereinafter) binarized by the quantization processing unit 44 are rearranged randomly on the basis of a predetermined random pattern.

The encryption processing unit 48 has a plurality of random patterns stored in the internal memory or the like in advance, together with corresponding key information, and selects one of the random patterns to perform encryption (random arrangement). There are various methods of selecting a random pattern, e.g., a method based on user selection and a method of automatically selecting a random pattern on the basis of image features. In this case, a method of using a default random pattern will be described.

In the example shown in FIG. 10, print data are randomly arranged to reverse the sequence of 255 data.

In step S302, the key information accompanying the random pattern that was referred to for random arrangement is added to a predetermined address of the randomly arranged print data. This key information is unique information for specifying the random pattern.

Referring to FIG. 10, key information A is added to the start address of the print data which is set as an address to which the key information should be added.

The print data which were randomly arranged and to which the key information was added by the above processing are transmitted to the printer 200.

In the printer 200, the code analyzing unit 33 shown in FIG. 3 decrypted the encrypted print data. In this decryption operation, the key information added to the print data is referred to. Like the encryption processing unit 48 on the PC 100 side, therefore, the code analyzing unit 33 must have random patterns corresponding to key information. As shown in FIG. 10, the decrypted print data become identical to the print data before encryption.

As described above, according to the encryption processing in this embodiment, a tracking pattern added to print data is randomly arranged, together with the print data. Even if, therefore, only an added tracking pattern substantially exists in a blank area where no print data exists, and a malicious user analyzes the print data in this area at the time of transmission of the data to the printer 200, it is difficult to detect the tracking pattern and tamper it. This makes it possible to improve the reliability of the printing system.

Note that the plurality of random patterns are held in the printer driver or the memory 11 or the like in the PC 100. In addition, the random patterns and corresponding key information can be added, changed, and deleted by a system manager.

As a method of random arrangement, the method of referring to random patterns has been described. However, encryption in this embodiment is not limited to this. For example, random arrangement based on a predetermined mathematical expression may be used. In this case, information representing the mathematical expression may be added as key information to a predetermined address of print data. Obviously, a known encryption method, e.g., the public key encryption scheme or private key encryption scheme, can be used.

As described above, in this embodiment, image data to which a tracking pattern is added can be encrypted to make it difficult to detect that the pattern is added and/or the position where the pattern is added.

As described above, according to this embodiment, the PC 100 encrypts image data to which a tracking pattern is added, and transmits the encrypted data to the printer 200. The printer 200 then decrypts the encrypted data and forms an image. This can prevent the tracking pattern from being tampered on the data communication path and hence improve the reliability of the tracking pattern in the formed image.

### Other Embodiment

The present invention may be applied to a system constituted by a plurality of devices (e.g., a host computer, an interface device, a reader, a printer, and the like) or an apparatus comprising a single device (e.g., a copying machine, a facsimile apparatus, or the like).

The object of the present invention is realized even by supplying a storage medium storing software program codes for realizing the functions of the above-described embodiment to a system or apparatus, and causing the computer (or a CPU or an MPU) of the system or apparatus to read out and execute the program codes stored in the storage medium. In this case, the program codes read out from the storage medium realize the functions of the above-described embodiment by themselves, and the storage medium storing the program codes constitutes the present invention. The functions of the above-described embodiment are realized not only when the readout program codes are executed by the computer but also when the OS (Operating System) running on the computer performs part or all of actual processing on the basis of the instructions of the program codes.

The functions of the above-described embodiment are also realized when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

When the present invention is applied to the above storage medium, program codes corresponding to the flow charts described above are stored in the storage medium.

As many apparently widely different embodiments of the present invention can be made without departing from the spirit and scope thereof, it is to be understood that the invention is not limited to the specific embodiments thereof except as defined in the appended claims.

What is claimed is:

1. An image processing apparatus comprising:
additional information generating means for generating additional information;
adding means for adding the additional information to image data to generate information-added data; and
encrypting means for encrypting the information-added data to make it difficult to detect that the additional information is added.

2. The apparatus according to claim 1, wherein said encrypting means encrypts the information-added data to make it difficult to detect a position where the additional information is added.

3. The apparatus according to claim 1, wherein said encrypting means adds key information for specifying an encryption method to the encrypted information-added data.

4. The apparatus according to claim 3, wherein said encrypting means encrypts the information-added data by randomly arranging the data.

5. The apparatus according to claim 4, wherein said encrypting means arranges the information-added data on the basis of a predetermined random pattern.

6. The apparatus according to claim 5, wherein the key information is information for specifying the random pattern.

7. The apparatus according to claim 1, further comprising transmitting means for transmitting the image data encrypted by said encrypting means to a connected image forming apparatus.

8. The apparatus according to claim 7, wherein the additional information includes first information for specifying the image forming apparatus.

9. The apparatus according to claim 8, wherein the first information is notified from the image forming apparatus.

10. The apparatus according to claim 8, wherein the additional information includes second information associated with a processing environment for the image data.

11. The apparatus according to claim 10, wherein the second information includes information for specifying the image processing apparatus.

12. The apparatus according to claim 11, wherein the information for specifying the image processing apparatus includes a network ID of the image processing apparatus.

13. The apparatus according to claim 12, wherein the network ID is acquired in accordance with a type of network to which the image processing apparatus is connected.

14. The apparatus according to claim 11, wherein the information for specifying the image processing apparatus include a user ID of the image processing apparatus.

15. The apparatus according to claim 10, wherein the second information includes processing date information of the image data.

16. The apparatus according to claim 1, wherein the image data is color image data made of a plurality of color components, and said adding means adds the additional information to data of a predetermined color component of the color image data.

17. An image processing method comprising:
the additional information generating step of generating additional information;
the adding step of adding the additional information to image data to generate information-added data; and
the encrypting step of encrypting the information-added data to make it difficult to detect that the additional information is added.

18. The method according to claim 17, wherein in the encrypting step, the information-added data is encrypted to make it difficult to detect a position where the additional information is added.

19. An image processing system having an image processing apparatus connected to an image forming apparatus,
said image processing apparatus including
additional information generating means for generating additional information,
adding means for adding the additional information to image data to generate information-added data,
encrypting means for encrypting the information-added data to make it difficult to detect that the additional information is added, and
transmitting means for transmitting the encrypted image data to said image forming apparatus, and
said image forming apparatus including
receiving means for receiving the encrypted data transmitted from said image processing apparatus,
decrypting means for obtaining the information-added data by decrypting the received encrypted data, and
image forming means for forming a visible image on the basis of the decrypted information-added data.

20. The system according to claim 20, wherein said encrypting means encrypts the information-added data to make it difficult to detect a position where the additional information is added.

21. The system according to claim 20, wherein
said encrypting means adds key information for specifying an encryption method to the encrypted information-added data, and
said decrypting means decrypts the encrypted data on the basis of the key information added by said encrypting means.

22. A program which is executed on a computer to make the computer operate as an image processing apparatus, the program including:
a code for the additional information generating step of generating additional information;
a code for the adding step of adding the additional information to image data to generate information-added data; and
a code for the encrypting step of encrypting the information-added data to make it difficult to detect that the additional information is added.

23. A storage medium storing the program defined in claim 22.
